(19) United States
(12) Patent Application Publication
(10) Pub. No.: US 2006/0025992 A1
(43) Pub. Date: Feb. 2, 2006

(54) Apparatus and method of eliminating noise from a recording device

(76) Inventor: Yoon-hark Oh, Suwon-si (KR)

Correspondence Address: STANZIONE & KIM, LLP, 919 18TH STREET, N.W., SUITE 440, WASHINGTON, DC, 20006, US

(21) Appl. No.: 11/102,776

(22) Filed: Apr. 11, 2005

(30) Foreign Application Priority Data
Jul. 27, 2004 (KR) 04-58849

(51) Int. Cl. G10L 21/02

(52) U.S. Cl. 704/226

(57) ABSTRACT

A noise elimination apparatus and method of eliminating noise content from a signal including the noise content and audio content input to a recording device, such as a camcorder. The method includes determining whether a noise frame exists by variably setting one or more thresholds independently in zones in which an estimated noise spectrum is updated according to an input audio spectrum of the audio signal, updating the estimated noise spectrum according to a noise spectrum of a previous frame and a noise spectrum of a current frame if the current frame is determined to be a noise frame, and subtracting the estimated noise spectrum from the input audio spectrum of the current frame.

### CROSS-REFERENCE TO RELATED APPLICATIONS

This application claims priority from Korean Patent Application No. 2004-58849, filed on Jul. 27, 2004 in the Korean Intellectual Property Office, the disclosure of which is incorporated herein in its entirety by reference.

### BACKGROUND OF THE INVENTION

1. Field of the Invention

The present general inventive concept relates to a recording device, and in particular, to a noise elimination apparatus and method of eliminating noise content when a signal including the noise content and a real audio content is input to the recording device.

2. Description of the Related Art

Conventionally, when a moving picture is recorded using a camcorder, noise is generated by revolution of a zoom motor or a drum motor. Since the noise is recorded in an audio signal through a microphone, sound quality deteriorates when the audio signal is reproduced.

Therefore, noise elimination technology for eliminating the noise has become necessary. Generally, noise elimination apparatuses use a conventional spectral subtraction method to eliminate background noise.

The conventional spectral subtraction method will now be described.

An analog signal input through a microphone is converted into a digital signal. The digital signal is divided into a plurality of frames (i.e., time windows) in a time axis domain to reduce information discontinuity between frames and distortion of the signal. The digital signal from which the frames are derived is converted to a frequency spectrum signal using a fast Fourier transform (FFT) operation.

Spectrum information includes magnitude spectrum information and phase spectrum information. The magnitude spectrum information is used for spectral subtraction, and the phase spectrum information is used for an inverse FFT (IFFT) operation.

The spectral subtraction is an operation of subtracting an estimated noise spectrum from a magnitude spectrum including a mixture of real audio content and noise content. Here, the noise spectrum of an audio region is typically calculated by averaging the magnitude spectrum of a noise region.

When noise characteristics are normal, the estimated noise spectrum is similar to an actual noise spectrum. Therefore, the magnitude spectrum obtained by the spectral subtraction is a magnitude spectrum of only the real audio content.

The magnitude spectrum obtained by the spectral subtraction and the phase spectrum are mixed and restored to produce an original signal in a time domain through the IFFT.

In the conventional spectral subtraction method, a frequency pattern of the noise content is estimated in advance, and when a signal in which the noise content and the real audio content are mixed is input, only the noise content is eliminated. However, if the frequency pattern of the noise content is inaccurately estimated, that is, if a frequency component of the real audio content is determined to be part of the noise content, a portion of the real audio content may erroneously be subtracted out with the noise content. Additionally, if the noise content is inaccurately estimated, only part of the noise content may be subtracted out. As a result, the conventional subtraction method is not capable of properly eliminating the noise content.

### SUMMARY OF THE INVENTION

The present general inventive concept provides a method of eliminating a noise content from an audio signal including the noise content by setting thresholds independently in zones in which a noise spectrum is updated according to the audio signal.

The present general inventive concept also provides a noise elimination apparatus and a recording device that use the noise elimination method.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of eliminating noise from an audio signal divided into a plurality of frames, the method comprising determining whether a noise frame exists by variably setting one or more thresholds independently in zones in which an estimated noise spectrum is updated according to an input audio spectrum of the audio signal, updating the estimated noise spectrum according to a noise spectrum of a previous frame and a noise spectrum of a current frame if the current frame is determined to be a noise frame, and subtracting the estimated noise spectrum from the input audio spectrum of the current frame.

The foregoing and/or other aspects and advantages of the present general inventive concept may also be achieved by providing a noise elimination apparatus usable with a recording device, comprising a FFT unit to calculate frequency spectrum information by performing a fast Fourier transform operation on an audio signal divided into a plurality of frames, a noise frame detector to determine a noise frame by setting thresholds independently in zones in which an estimated noise spectrum is updated according to the frequency spectrum calculated by the FFT unit, a noise spectrum update unit to update the estimated noise spectrum using a noise spectrum of a current frame and a noise spectrum of a previous frame if the current frame is determined by the noise frame detector to be a frame in which only noise exists, a spectrum subtractor to subtract the estimated noise spectrum updated by the noise spectrum update unit from the spectrum of the audio signal, an adder adding an audio spectrum output from the spectrum subtractor to phase spectrum information output from the FFT unit, and an IFFT unit to restore an audio spectrum output from the adder into an original signal in a time domain through an inverse fast Fourier transform operation.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a noise elimination apparatus of a recording device according to an embodiment of the present general inventive concept;

FIG. 2 is a flowchart illustrating a method of detecting a noise frame in a noise frame detector of FIG. 1;

FIGS. 3A through 3C are waveform diagrams illustrating a process of updating a noise spectrum; and

FIGS. 4A and 4B are waveform diagrams illustrating audio signals before and after a noise subtraction method according to an embodiment of the present general inventive concept is applied.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

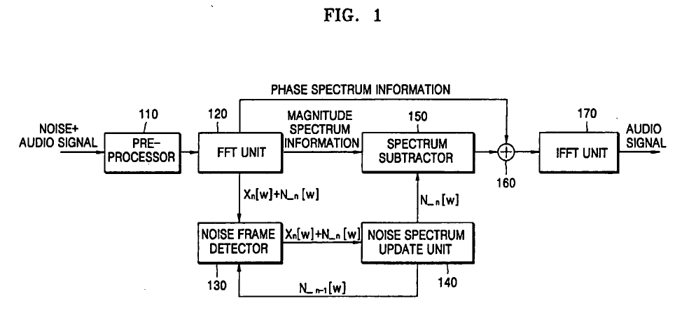

FIG. 1 is a block diagram illustrating a noise elimination apparatus of a recording device according to an embodiment of the present general inventive concept.

Referring to FIG. 1, the noise elimination apparatus includes a pre-processor 110, a fast Fourier transform (FFT) unit 120, a noise frame detector 130, a noise spectrum update unit 140, a spectrum subtractor 150, an adder 160, and an inverse fast Fourier transform (IFFT) unit 170.

An analog signal input through a microphone is converted into a digital signal. The analog signal comprises an audio signal and includes a noise content and a real audio content mixed together.

The pre-processor 110 divides the audio signal in which the noise content and the real audio content are mixed into a plurality of frames and windows the audio signal according to the frames. A Hamming windows or Hanning windows can be used to window the audio signal into the frames. The windows mitigate effects of discontinuities at endpoints of the frames.

The FFT unit 120 converts the audio signal that is divided into the frames by the pre-processor 110 into frequency spectrum information using an FFT operation. The frequency spectrum information includes magnitude spectrum information and phase spectrum information about the audio signal. The magnitude spectrum information is used in frequency subtraction, and the phase spectrum information is used in an IFFT operation.

The noise frame detector 130 determines whether a current frame FFT processed by the FFT unit 120 includes only noise content (i.e., is a “noise only” frame) or whether the current frame includes both noise content and real audio content according to a comparison of the current frame three thresholds. If it is determined that the current frame includes only noise content, the noise frame detector 130 outputs the current frame {X_n[w]+N_n[w]} to the noise spectrum update unit 140. That is, the noise frame detector 130 determines that a current frame is a noise only frame when the current frame simultaneously satisfies three conditions including a first threshold that is compared to an energy of the current frame, a second threshold that is compared to a difference between the energy of a spectrum of the current frame and an energy of an estimated noise spectrum, and a third threshold that is compared to a difference between the spectrum of the current frame and the estimated noise spectrum. The first, second, and third thresholds are independently set according to zones in which the estimated noise spectrum is updated. The estimated noise spectrum is updated according to a noise spectrum of the current frame and a noise spectrum of a previous frame.

The noise spectrum update unit 140 updates a current estimated noise spectrum using the spectrum {X_n[w]+N_n[w]} of the current frame (including both the real audio content X_n[w] and the noise content N_n[w] and a previous estimated noise spectrum when it is determined that the current frame includes only noise content. That is, a noise spectrum updated by the noise spectrum update unit 140 is given by:
N_{—}n[w]=N_{—}n−1[w]*(1−α)+{X_{—}n[w]+N_{—}n[w]}*α.
Here, N_n−1[w] is the noise spectrum of the previous frame, X_n[w] is a real audio spectrum of the current frame, N_n[w] is a noise spectrum of the current frame, and α is a noise spectrum update coefficient. The real audio spectrum of the current frame X_n[w] may equal to 0, and the noise spectrum update coefficient α may equal 0.2.

The spectrum subtractor 150 subtracts the estimated noise spectrum updated by the noise spectrum update unit 140 from the spectrum of the current frame corresponds to the magnitude spectrum information to obtain the real audio spectrum of the current frame.

The adder 160 adds the real audio spectrum of the current frame output from the spectrum subtractor 150 to the phase spectrum information output from the FFT unit 120.

The IFFT unit 170 restores magnitude and phase spectrum information of the real audio signal output from the adder 160 to an audio signal in the time domain through the IFFT.

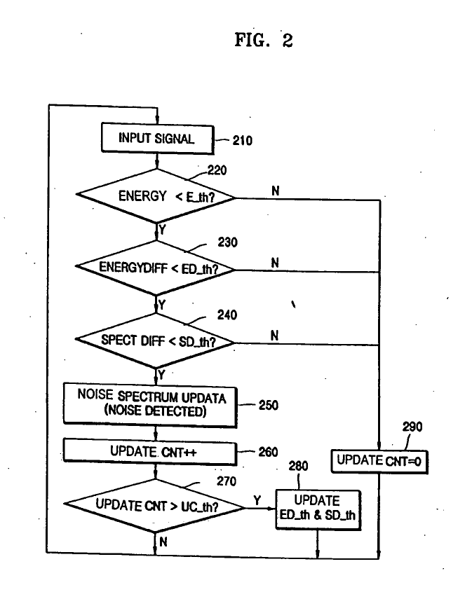

FIG. 2 is a flowchart illustrating a method of detecting a noise frame in the noise frame detector 130 of FIG. 1.

Referring to FIG. 2, an audio signal is converted into a frequency spectrum for the frames in operation 210.

An energy of the audio signal is monitored. The energy of a current frame of the audio signal is compared with a first energy threshold E_th in operation 220. Since an energy of a frame including only noise content is less than that of a frame including both noise content and real audio content, the energy of the current frame must be less than the first energy threshold E_th if the current frame is a noise only frame. If the energy of the current frame is greater than the first energy threshold E_th, an update count UpdateCNT is initialized to 0 in operation 290.

If the energy of the current frame is less than the first energy threshold E_th, a variation in energies of the frames of the audio signal is monitored. A difference ENERGYDIFF between the energy of the current frame and an energy of a noise spectrum updated in a previous frame is compared with a second energy difference threshold ED_th in operation 230. Since energy variation of a noise only frame is less than that of a frame including both noise content and audio content, the energy difference between the current frame and the noise spectrum updated in the previous frame must be less than the second threshold energy difference ED_th if the current frame is a noise only frame. If the energy difference is greater than the second threshold ED_th, UpdateCNT is initialized to 0 in operation 290.

If the difference between the energy of the current frame and the energy of the noise spectrum updated in the previous frame is less than the second energy difference threshold ED_th, a variation in spectra of the audio signal is monitored. A difference SPECTDIFF between a spectrum of the current frame and the noise spectrum updated in the previous frame is compared with a third spectrum difference threshold SD_th in operation 240. Since spectrum variation of a noise only frame is less than that of a frame including both noise content and audio content, the spectral difference between the current frame and the noise spectrum updated in the previous frame must be less than the third spectrum difference threshold SD_th if the current frame is a noise only frame. If the spectral difference is greater than the third spectrum difference threshold SD_th, UpdateCNT is initialized to 0 in operation 290.

If the difference between the spectrum of the current frame and the noise spectrum updated in the previous frame is less than the third spectrum difference threshold SD_th, it is determined that the current frame is the noise only frame and includes only noise content, and a noise spectrum update is performed in operation 250.

When the energy, the energy difference, and the spectral difference are less than the first energy, second energy difference, and third spectrum difference thresholds, respectively, UpdateCNT is increased by 1 (i.e., UpdateCNT++) in operation 260. UpdateCNT is a variable that keeps track of a number of consecutive noise only frames.

If UpdateCNT is larger than a threshold UC_th in operation 270, ED_th and SD_th are updated in operation 280 according to a noise spectrum of the current frame. The method illustrated in FIG. 2 compares the energy of the current frame and the spectrum of the current frame to the noise spectrum updated in a previous frame to determine whether the current frame is a noise only frame. If the current frame is determined to be a noise only frame the noise spectrum update unit 140 updates the noise spectrum updated in a previous frame to a new updated noise spectrum to compare to spectrums of subsequent frames of the audio signal. Thus, once the noise spectrum is updated, the spectrums of the subsequent frames are compared to the new updated noise spectrum until another noise only frame is detected among the subsequent frames, at which point the new updated noise spectrum is updated again. The first energy, second energy difference, and third spectrum difference thresholds are set such that the noise frame detector 130 detects whether the current frame is a noise only frame. The thresholds are updated when a certain number (i.e., UC_th) of consecutive noise only frames are detected.

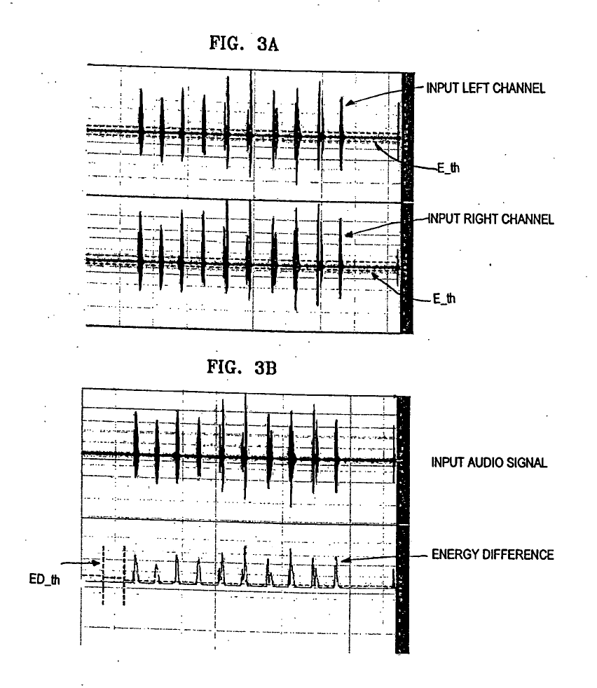

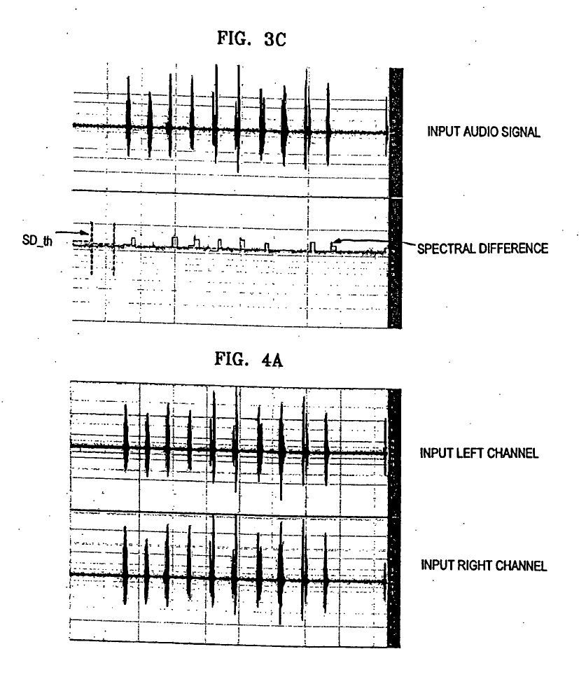

FIGS. 3A through 3C are waveform diagrams illustrating a process of updating a noise spectrum.

An experientially determined characteristic of an initial noise spectrum may differ from a characteristic of a current input noise spectrum. In this case, the initial noise spectrum must be updated according to the current input noise spectrum. A process of updating the initial noise spectrum will now be described with reference to changes of the first energy, second energy difference, and third spectrum difference thresholds illustrated in FIGS. 3A through 3C. FIG. 3A illustrates an energy of a current frame input through left and right channels and the first energy threshold E_th (dot line). FIG. 3B illustrates a difference between the energy of the current frame and an energy of a noise spectrum updated in a previous frame, and the second threshold ED_th (dotted line). Here, the upper waveform of FIG. 3B indicates an input audio signal and the lower waveform of FIG. 3B indicates a contour representing the energy difference. FIG. 3C illustrates a difference between a spectrum of the current frame and the noise spectrum updated in the previous frame and the third threshold SD_th (dotted line). Here, the upper waveform of FIG. 3C indicates the input audio signal and the lower waveform of FIG. 3C indicates a contour that represents the spectral difference.

Referring to FIGS. 3A through 3C, the initial noise spectrum is allowed to approximate the input noise spectrum by setting the first, second, and third thresholds to large values during the first 10 noise spectrum update periods. Then, the noise spectrum is updated by accurately detecting frames including noise content and audio content by decreasing the second and third thresholds ED_th and SD_th during the next 10 noise spectrum update periods. Finally, the noise spectrum is updated by detecting noise only frames precisely by strictly setting the second and third thresholds ED_th and SD_th during the next noise spectrum update periods.

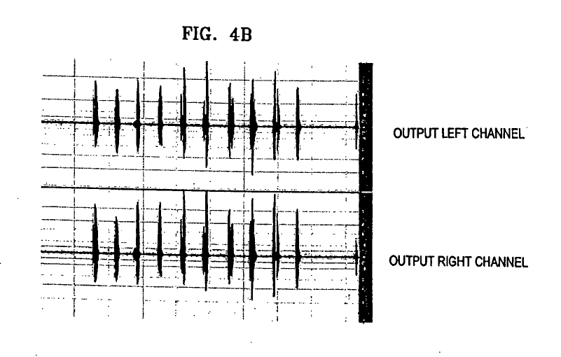

FIGS. 4A and 4B are waveform diagrams showing left and right channel audio signals before and after a noise subtraction method according to an embodiment of the present general inventive concept is applied. Although FIGS. 3A, 4A, and 4B illustrate left and right channel audio signals, other types of audio channel signals may be used with the present general inventive concept.

Referring to FIGS. 4A and 4B, by adapting the noise elimination method according to an embodiment of the present general inventive concept, only noise content eliminated, and an output audio signal has approximately no noise content.

As described above, according to an embodiment of the present general inventive concept, sound quality of an audio signal recorded in an audio recording apparatus, such as a camcorder, can be greatly improved by eliminating only noise while not affecting a real audio signal by setting varying thresholds according to zones in which a noise spectrum of an input signal is updated. When the camcorder includes a recording unit or mechanism, a noise corresponding to the noise spectrum is generated from the recording unit or mechanism. Thus, the real audio signal is received by a microphone of an input unit and includes audio generated outside the camcorder and may not include the noise generated by the recording unit or mechanism.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of eliminating noise from an audio signal divided into a plurality of frames, the method comprising:
determining whether a noise frame exists by variably setting one or more thresholds independently in zones in which an estimated noise spectrum is updated according to an input audio spectrum of the audio signal;
updating the estimated noise spectrum according to a noise spectrum of a previous frame and a noise spectrum of a current frame if the current frame is determined to be the noise frame; and
subtracting the updated noise spectrum from the input audio spectrum of the current frame.

2. The method of claim 1, wherein the determining of whether the noise frame exists comprises comparing the one or more thresholds with energy of the current frame, a difference between energy of the input audio spectrum of the current frame and energy of the estimated noise spectrum, and a difference between the input audio spectrum of the current frame and the estimated noise spectrum, respectively.

3. The method of claim 1, wherein the determining of whether the noise frame exists comprises approximating an input noise spectrum using an initial noise spectrum of the audio signal.

4. The method of claim 1, wherein the one or more thresholds comprise first, second, and third thresholds, and the determining of whether the noise frame exists comprises determining that the current frame is a noise frame if energy of the current frame is less than the first threshold, a difference between the energy of the current frame and an energy of the estimated noise spectrum updated in a previous frame is less than the second threshold, and a difference between the input audio spectrum of the current frame and the estimated noise spectrum updated in the previous frame is less than the third threshold.

5. The method of claim 4, further comprising:
setting the first, second, and third thresholds independently according to the zones in which the estimated noise spectrum is updated,
wherein the noise spectrum is updated when the current frame satisfies conditions of the first, second, and third thresholds.

6. A method of a noise eliminating apparatus, the method comprising:
comparing frequency characteristics of a signal divided into a plurality of frames with an estimated noise spectrum;
determining whether the estimated noise spectrum accurately approximates an actual noise spectrum according to the results of the comparison; and
updating the estimated noise spectrum when the estimated noise spectrum is determined not to accurately approximate the actual noise spectrum.

7. The method of claim 6, further comprising:
subtracting the estimated noise spectrum from a current frame of the signal; and
outputting a signal without the noise content.

8. The method of claim 6, wherein the updating of the estimated noise spectrum comprises changing the estimated noise spectrum to a noise spectrum of a current frame.

9. The method of claim 8, wherein the estimated noise spectrum is updated whenever the current frame contains only noise content.

10. The method of claim 6, wherein the determining of whether the estimated noise spectrum accurately approximates the actual noise spectrum comprises determining whether a current frame contains only noise content by comparing an energy of the current frame with a first threshold, comparing an energy difference between the current frame and the estimated noise spectrum with a second threshold, and comparing a difference of a spectrum of the current frame and the estimated noise spectrum with a third threshold.

11. The method of claim 10, wherein the current frame is determined to contain only noise content when the energy of the current frame is less than the first threshold, the energy difference between the current frame and the estimated noise spectrum is less than the second threshold, and the difference of the spectrum of the current frame and the estimated noise spectrum is less than the third threshold.

12. The method of claim 11, wherein the first, second, and third thresholds are set to be larger than an expected energy of a frame containing only noise content, an expected energy difference between a frame containing only noise content and the estimated noise spectrum, and an expected spectral difference between a frame containing only noise content and the estimated noise difference, respectively.

13. The method of claim 11, wherein the first, second, and third thresholds are updated after a predetermined number of consecutive frames containing only noise content are determined.

14. The method of claim 11, wherein the updating of the estimated noise spectrum when the estimated noise spectrum does not accurately approximate the actual noise spectrum comprises:
setting the first, second, and third thresholds to relatively large values during a first number of noise spectrum update periods;
updating the estimated noise spectrum during a second number of noise spectrum update periods while decreasing the first, second, and third thresholds; and
updating the estimated noise spectrum according to a comparison of a current frame and the estimated noise spectrum during a third number of noise spectrum update periods.

15. The method of claim 6, wherein the estimated noise spectrum is updated according to the following:
N_{—}n[w]=N_{—}n−1[w]*(1−α)+{X_{—}n[w]+N_{—}n[w]}*α
where N_n[w] is the updated noise spectrum, N_n−1[w] is an estimated noise spectrum updated in a previous frame, a is a noise spectrum update coefficient, and {X_n[w]+N_n[w]} is a spectrum of a current frame.

16. A noise elimination apparatus comprising:
a FFT unit to generate frequency spectrum information by performing a fast Fourier transform operation on an audio signal divided into a plurality of frames;
a noise frame detector to determine a noise frame by variably setting thresholds independently in zones in which an estimated noise spectrum is updated according to the frequency spectrum information generated by the FFT unit;
a noise spectrum update unit to update the estimated noise spectrum using a noise spectrum of a current frame and a noise spectrum of a previous frame if the current frame is determined by the noise detector to be a frame in which only noise exists; and
a spectrum subtractor to subtract the estimated noise spectrum updated by the noise spectrum update unit from the spectrum of the audio signal to generate a real audio spectrum.

17. The apparatus of claim 16, wherein the noise frame detector comprises:
one or more comparators to compare an energy of the current frame with a first threshold, to compare an energy difference between the energy of the current frame and an energy of a noise spectrum updated in a previous frame with a second threshold, and to compare a spectral difference between a spectrum of the current frame and the noise spectrum updated in the previous frame with a third threshold; and
a determination unit to determine the current frame to be a noise frame if the energy, the energy difference, and the spectral difference of the current frame are less than the first, second, and third thresholds, respectively.

18. The apparatus of claim 17, wherein the noise frame detector sets the first, second, and third thresholds to indicate whether the estimated noise spectrum accurately approximates an actual noise spectrum of the current frame, and the estimated noise spectrum is updated when the current frame satisfies conditions of the first, second, and third thresholds.

19. The apparatus of claim 16, further comprising:
an adding unit to add the real audio spectrum and phase spectrum information generated from the FFT unit.

20. A noise elimination apparatus in a recording device, the apparatus comprising:
a FFT unit to calculate a frequency spectrum information by performing a fast Fourier transform operation on an audio signal divided into a plurality of frames;
a noise frame detector to determine a noise frame by variably setting thresholds independently in zones in which an estimated noise spectrum is updated according to the frequency spectrum calculated by the FFT unit;
a noise spectrum update unit to update the estimated noise spectrum using a noise spectrum of a current frame and a noise spectrum of a previous frame if the current frame is determined by the noise frame detector to be a frame in which only noise exists;
a spectrum subtractor to subtract the estimated noise spectrum updated by the noise spectrum update unit from the spectrum of the audio signal;
an adder to add an audio spectrum output from the spectrum subtractor to phase spectrum information output from the FFT unit; and
an IFFT unit to restore an audio spectrum output from the adder into an original signal in a time domain through an inverse fast Fourier transform operation.

21. A recording device, comprising:
a recording unit having a recording mechanism to generate a noise signal;
an input unit to receive a real audio signal; and
a noise elimination apparatus to receive an audio signal including the noise signal and the real audio signal, to divide the audio signal into a plurality of frames, to determine whether a noise frame exists according to one or more thresholds set independently in zones in which a noise spectrum is updated according to an input audio spectrum of the audio signal, and to subtract the noise spectrum from the input audio spectrum of a current frame of the plurality of frames.

22. A recording device, comprising:
a noise elimination apparatus to determine whether a noise frame exists by variably setting one or more thresholds independently in zones in which an estimated noise spectrum is updated according to an input audio spectrum of the audio signal, to update the estimated noise spectrum according to a noise spectrum of a previous frame and a noise spectrum of a current frame if the current frame is determined to be the noise frame, and to subtract the updated noise spectrum from the input audio spectrum of the current frame.

23. The recording device of claim 22, wherein the recording device comprises a camcorder.

24. The recording device of claim 22, further comprising:
a recording unit having a recording mechanism to generate the noise spectrum.

25. The recording device of claim 22, further comprising:
an input unit having a microphone to receive a real audio spectrum.
